(19) United States
(12) Patent Application Publication
(10) Pub. No.: US 2025/0384107 A1
(43) Pub. Date: Dec. 18, 2025

(54) IRREGULAR SPARSE MATRIX MULTIPLY

(71) Applicant: NVIDIA Corporation, Santa Clara, CA (US)

(72) Inventor: William James Dally, Incline Village, NV (US)

(21) Appl. No.: 18/825,805

(22) Filed: Sep. 5, 2024

Related U.S. Application Data
(60) Provisional application No. 63/660,891, filed on Jun. 17, 2024.

(51) Int. Cl. G06F 17/16

(52) U.S. Cl. CPC G06F 17/16

(57) ABSTRACT

A sparse dot product and/or matrix multiply is computed by subdividing each vector and simultaneously performing operations to generate output matrix elements. In an embodiment, a bit mask is computed that includes one bit for each element of an input matrix, each bit indicating whether the element is non-zero or zero. In an embodiment, the element values are stored in a packed format, where all of the non-zero values are packed together and the remaining storage for the matrix contains zeros (or any other values). The bit mask can then be used to determine the location of each non-zero element in the packed storage. Rather than reading all of the elements, only the non-zero elements that will be multiplied by a non-zero element from the other input vector should be read. Any multiplication by a zero element from either input vector or matrix is unnecessary.

### CLAIM OF PRIORITY

This application claims the benefit of U.S. Provisional Application No. 63/660,891 (Attorney Docket No. 514779) titled “Irregular Sparse Matrix Multiply Unit,” filed Jun. 17, 2024, the entire contents of which is incorporated herein by reference.

### BACKGROUND

Multiplying two matrices requires computing a dot product of a row vector from a multiplier matrix and a column vector from a multiplicand matrix for each element of the resulting product matrix. When the two matrices are sparse, meaning many of the elements are zeros, multiplying by the zero valued elements does not contribute to the resulting product matrix. Power consumption may be reduced by performing multiplications only when both input elements are non-zero. There is a need for addressing these issues and/or other issues associated with the prior art.

### SUMMARY

Embodiments of the present disclosure relate to an irregular sparse matrix multiply. Systems and methods are disclosed for efficiently computing a sparse dot product and/or matrix multiply. M²N parallelism is achieved by dividing each vector for the dot product computations into N sub-vectors and then operating on M rows/columns (or output matrix elements) simultaneously. In an embodiment, a bit mask is computed that includes one bit for each element of an input matrix, each bit indicating whether the element is non-zero or zero. In an embodiment, the element values are stored in a packed format, where all of the non-zero values are packed together and the remaining storage for the matrix contains zeros (or any other values). The bit mask can then be used to determine the location of each non-zero element in the packed storage. Rather than reading all of the elements, only the non-zero elements may be read. More importantly, only the non-zero elements that will be multiplied by a non-zero element from the other input vector should be read. Any multiplication by a zero element from either input vector or matrix is unnecessary.

In an embodiment, the method for performing an operation using sparse input vectors includes partitioning a first input vector into first sub-vectors, partitioning a second input vector into second sub-vectors, and obtaining an intersection bit mask indicating non-zero partial products for a combination of the first input vector and the second input vector. A set of first buffers associated with the first sub-vectors is written with first elements in the first sub-vectors corresponding to the non-zero partial products. A set of second buffers associated with the second sub-vectors is written with second elements in the second sub-vectors corresponding to the non-zero partial products. The non-zero partial products for each pair of elements including one of the first elements and one of the second elements are computed, according to the intersection bit mask. The non-zero partial products are summed to produce a dot product of the first input vector and the second input vector.

### BRIEF DESCRIPTION OF THE DRAWINGS

The present systems and methods for an irregular sparse matrix multiply are described in detail below with reference to the attached drawing figures, wherein:

FIG. 1A illustrates a conceptual diagram of a vector memory storing a 64 element vector partitioned into 8 sub-vectors, each of length 8, in accordance with an embodiment.

FIG. 1B illustrates a conceptual diagram of the bit mask and the associated 64 element vector, in accordance with an embodiment.

FIG. 1C illustrates a conceptual diagram of the bit mask and the associated 64 element vector in a packed format, in accordance with an embodiment.

FIG. 2A illustrates a block diagram of an example dot product unit suitable for use in implementing some embodiments of the present disclosure.

FIG. 2B illustrates a block diagram of buffers and a scanning unit, in accordance with an embodiment.

FIG. 3A illustrates a block diagram of a matrix multiply unit, in accordance with an embodiment.

FIG. 3B illustrates a block diagram of a memory unit, in accordance with an embodiment.

FIG. 3C illustrates a flowchart of a method performing an operation using sparse input vectors suitable for use in implementing some embodiments of the present disclosure.

FIG. 4 illustrates an example parallel processing unit suitable for use in implementing some embodiments of the present disclosure.

FIG. 5A is a conceptual diagram of a processing system implemented using the PPU of FIG. 4, suitable for use in implementing some embodiments of the present disclosure.

FIG. 5B illustrates an exemplary system in which the various architecture and/or functionality of the various previous embodiments may be implemented.

FIG. 5C illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed related to an irregular sparse matrix multiply. M²N parallelism is achieved by dividing each vector for dot product computations into N sub-vectors and then operating on M rows/columns (or output matrix elements) simultaneously. In an embodiment, a bit mask is computed that includes one bit for each element of an input matrix, each bit indicating whether the element is non-zero or zero. In an embodiment, the element values are stored in a packed format, where all of the non-zero values are packed together and the remaining storage for the matrix contains zeros (or any other values). The bit mask can then be used to determine the location of each non-zero element in the packed storage. Rather than reading all of the elements, only the non-zero elements may be read from small local memories (buffers). More importantly, only the non-zero elements that will be multiplied by a non-zero element from the other input vector should be read. Any multiplication by a zero element from either input vector or matrix is unnecessary.

Each sparse vector may be represented as a bit mask (bit vector or bit mask) and a vector of non-zero values. Each bit of the bit mask indicates whether a corresponding location of the element vector contains a non-zero value. The vector of non-zero values contains the values for each non-zero element of the sparse vector. For example, the sparse vector A=[0,0,3,0,4,0,0,0,5] would be represented by a bit mask A_{b}=001010001 and a vector of non-zero values Aᵥ=[3,4,5].

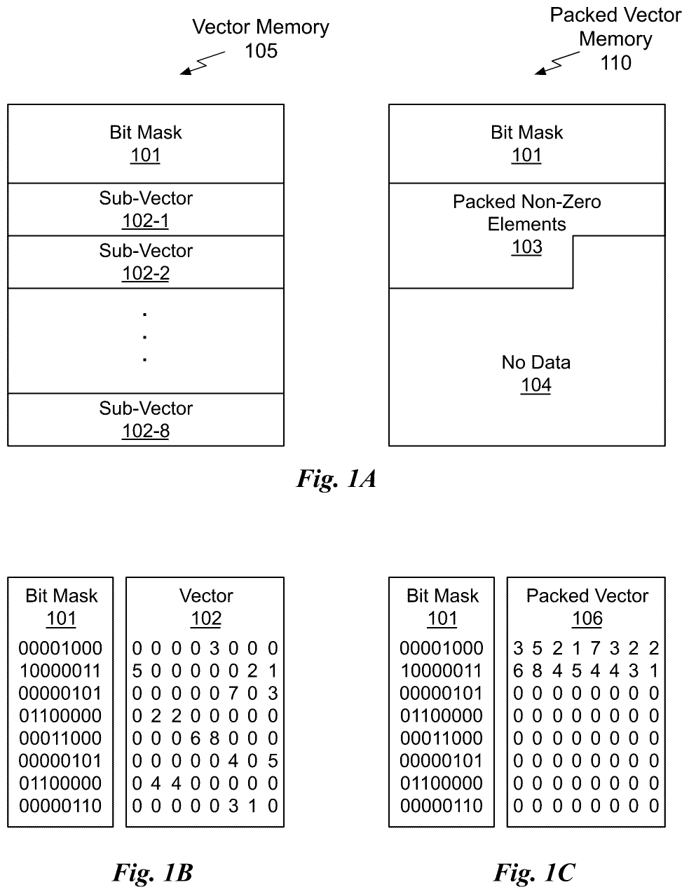

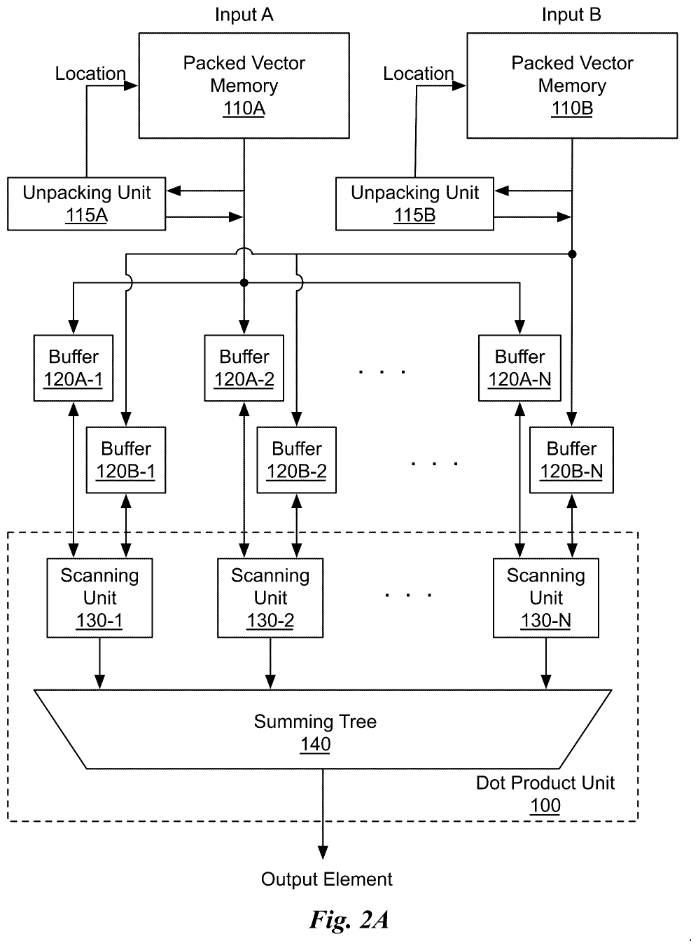

FIG. 1A illustrates a conceptual diagram of a vector memory 105 storing a 64 element vector 102 partitioned into N=8 sub-vectors 102-N, each of length 8, in accordance with an embodiment. A bit mask 101 indicates the non-zero elements in the vector. In an embodiment, a binary one or TRUE in the bit mask 101 indicates each non-zero element. FIG. 1A illustrates a packed vector memory 110 that stores the same bit mask 101 and the 64 element vector 102 in a packed format.

FIG. 1B illustrates a conceptual diagram of the bit mask 101 and the associated 64 element vector 102, in accordance with an embodiment. The bit mask 101 is 64 bits and the 64 element vector 102 includes 8 rows, where each row is a sub-vector 102-N.

FIG. 1C illustrates a conceptual diagram of the bit mask 101 and the associated 64 element vector 102 in a packed format, in accordance with an embodiment. The non-zero elements of the 64 element vector 102 are stored in packed non-zero elements 103. The remaining entries of the packed vector memory 110 store no data 104 (or previously stored data for another vector). The packed format of the vector 102, packed vector 106 includes the packed non-zero element 103 followed by the no data 104 (shown as zeros).

To determine which multiplications should be performed for a dot product operation, the two bit masks for two input vectors are combined using a bitwise AND operation or intersection to produce a relevance bit mask. Any element that will contribute to a non-zero partial product (product resulting from multiplying two elements) should be read from the packed vector memory for a multiply operation. For a row of a matrix multiply operation, the relevance vector is the AND of the row's non-zero bit mask and the OR of all of the column non-zero bit masks to be operated on. In an embodiment, the relevance vector is not computed and is replaced with the bit masks A_{b} and B_{b} and all non-zero elements are read from the packed vector memories 110A and 110B, respectively. Without computing the relevance vector, more non-zero elements will likely be read from the packed vector memories 110A and 110B. In an embodiment, the relevance vector is computed as the packed vector memories 110A and 110B are written and the relevance vector is stored in the packed vector memories 110A and 110B.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

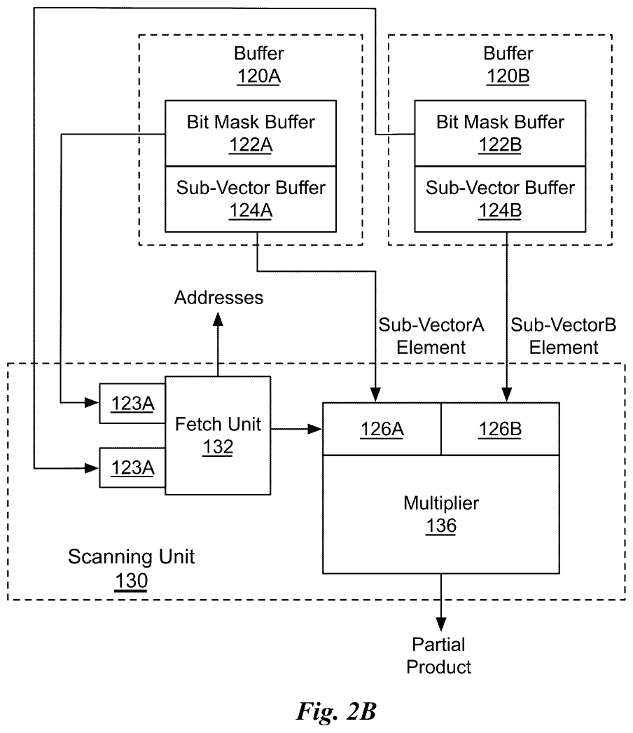

FIG. 2A illustrates a block diagram of an example dot product unit 100 suitable for use in implementing some embodiments of the present disclosure. Packed vector memories 110A and 110B store the two input vectors (multiplier A and multiplicand B) for the dot product operation. The dot product unit 100 computes one output element as a scalar vector product of the two input vectors. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the dot product unit 100 is within the scope and spirit of embodiments of the present disclosure.

In an embodiment, the relevance vectors are not stored in the packed vector memories 110A and 110B and for each sub-vector, the sub-vector bit masks for the input vectors A and B are read by unpacking units 115A and 115B. Each unpacking unit 115 then computes a portion of the relevance bit mask corresponding to the sub-vectors to be processed by each particular scanning unit 130. The relevance bit mask is used by the unpacking units 115A and 115B to determine which non-zero elements of the input vectors A and B are unpacked and loaded into the buffers 120A and 120B, respectively. For each non-zero bit in the sub-vector relevance bit mask, the unpacking units 115A and 115B initiate a transfer from the packed vector memory 110A and 110B, respectively, to a buffer 120A and 120B, respectively.

The bit mask for the input vector A and the bit mask for the vector B are also read by the unpacking units 115A and 115B and loaded into the buffers 120A and 120B, respectively. The bit masks for the input vectors are needed by scanning units 130 to compute addresses where the unpacked sub-vectors are stored in the buffers 120. In an embodiment, the buffers 120 store the non-zero elements separately from the bit masks, allowing the scanning units 130 to read the bit masks separately from the non-zero elements and compute the intersection bit masks.

The unpacking unit 115A computes a location (position c) in the packed vector memory 110A from which to read the non-zero values by keeping a running count of the non-zero bits in the bit mask. For example, for a bit mask A_{b} of 0010110010001110, the running count A_{c} is 0001123334444567. Each element of A_{c} is computed as A_{c}[i]=A_{c}[i−1]+A_{b}(i−1). The address is a position i, of the non-zero bit in the input vector A. In an embodiment, pseudocode for the unpacking unit 115A is shown in TABLE 1. The unpacking unit 115B operates in the same manner as the unpacking unit 115A, using the relevance bit mask Br and a running count B_{c}. The one-hot bit-pointer b is initialized to a value of zero which corresponds to a one in the position off the left (LSB) side of the respective input vector. The moreOnes(b, Aᵣ) function returns one if there are any ones in Aᵣ to the right of the one in b. The nextOne(b, Aᵣ) function called with b=0 returns the first (left-most) one in Aᵣ. Ap is the packed vector memory 110A and c is the location to read from in the packed vector memory 110A and store in address (index) b of the buffer 120A, thereby unpacking the non-zero elements as they are stored to the buffer 120A.

TABLE 1
example unpacking pseudocode

```
b = 0 ; // one hot vector denoting current scan position
    //0 means off the left side, bit −1
while(MoreOnes(b,Ar)) {
  b = nextOne(b,Ar) ; // find next one in relevance vector
  c = Ac[b] ; // position in Ap
  A[b] <− Ap[c] ; // do transfer
```

In an embodiment, the bit masks A_{b} and B_{b} are stored in the packed vector memories 110A and 110B, respectively and are read a word (8, 16, or 32 bits) at a time, where p is a word pointer. In an embodiment, pseudocode for the unpacking unit 115A to read each word, where MAX_P corresponds to a maximum word pointer is shown in TABLE 2. The word pointer p and running count of the non-zero bits in the bit mask for the input A, Acb are each initialized to zero. The bit mask is read from the packed vector memory 110A using the pointer p to produce Abb. Then, Acb is updated by counting the non-zero bits in Abb. The relevance bit mask is read from the packed vector memory 110A using the pointer p to produce Arb. The while loop is executed for each non-zero bit of the relevance bit mask to copy each non-zero element corresponding to a non-zero relevance bit mask from the packed vector memory 110A to the unpacked buffer 120A.

TABLE 2
example word unpacking pseudo code

```
p = 0 ; // word pointer
Acb = 0 ; // zero one's counter
while(p <= MAX_P) { // for each word
  Abb = Ab[p] ;
  Acb = Count(Abb, Acb[n−1]) ; // count of non-zero bits
  Arb = Ar[p] ;
  If(Arb != 0) {
    b = 0 ;
    while(MoreOnes(b,Arb)) {
      b = nextOne(b,Arb) ; // find next one in relevance vector
      c = Acb[b] ; // position in Ap
      X = {p, b} ; // position in A
      Transfer(c, X) ; // do transfer
    }
  }
  p = p + 1 ;
}
```

In an embodiment, in a first phase of scanning performed by the unpacking units 115, the non-zero elements of the input vectors A and B stored in the packed format are unpacked as they are loaded into the buffers 120A and 120B, respectively. In other words, the buffers 120 are capable of storing the worst case sub-vector which includes 256 non-zero elements. Therefore, each non-zero element is stored in the buffer 120 in the unpacked format. However, only the non-zero elements need to be loaded into the buffers 120 and any unloaded locations can retain the previously written element rather than being loaded with a zero. It is not necessary to clear the old values each time the buffers 120 are loaded. In an embodiment, all non-zero elements of the A and B sub-vectors are loaded into the buffers 120A and 120B, respectively. However, power consumption is reduced by only loading the elements of the sub-vectors A and B that are associated with non-zero bits in the sub-vector relevance bit mask. In an embodiment, only the non-zero elements of the A and B sub-vectors that will contribute to a non-zero partial product (according to the sub-vector relevance bit mask) are loaded into the buffers 120A and 120B, respectively.

In a second phase, each scanning unit 130 computes an intersection vector and reads the non-zero elements indicated by the intersection vector from the buffers 120A and 120B to compute partial products. Overall, the dot product unit 100 multiplies elements from an input vector A and input vector B to compute partial products that are each associated with a non-zero bit in the intersection bit mask. The partial products are summed by a summing tree 140 to produce the dot product result (output element). Input vectors A and B are partitioned into N sub-vectors that are stored in the packed vector memories 110A and 110B, respectively. For example, when each vector has a length L=4,096 and N=16, each input vector A and B is partitioned into 16 sub-vectors of L1=256 elements. The portion of the intersection bit mask (sub-vector intersection bit mask) is 256 bits.

FIG. 2B illustrates a block diagram of buffers 120A and 120B and a scanning unit 130, in accordance with an embodiment. Each buffer 120 includes a bit mask buffer 122 for storing the sub-vector bit masks and a sub-vector buffer 124 for storing the unpacked non-zero elements for a sub-vector. In an embodiment, the bit mask buffers 122 have an output port that is L2 (e.g., L2=8 or 16) bits wide, so 256 bits of the sub-vector bit masks may be read by the scanning units 130 from the bit mask buffers 122 over 32 or 16 processing cycles, respectively. The sub-vector bit masks A and B are stored in registers 123A and 123B within the scanning unit 130, respectively. In an embodiment, the sub-vector buffers 124 also have an output port that is one element wide. An element may be any suitable numerical format such as 1,2,4, 8, or 16-bit integer, 4,8, or 16-bit floating point, logarithmic, or symbolic. Elements read from the buffer are stored into registers 126A and 126B. The N scanning units 130 read the sub-vector bit masks to compute the sub-vector intersection bit mask and find locations where both sub-vectors A and B have non-zero elements. At each such location the scanning units 130 will output a partial product to the summing tree 140 which combines outputs from the N scanning units 130 and adds the partial product to a result until the output element is computed. Typically, each scanning unit 130 produces one partial product per processing cycle. However, a long string of zeros in the intersection bit masks may cause a scanning unit 130 to skip a processing cycle, and because each sub-vector may have a different number of non-zeros, the scanning units 130 may finish at different times.

In an embodiment, the registers 123A and 123B holding the current L2 bits of each bit mask are double buffered so that the next bit masks for the next sub-vector can be loaded into the bit mask registers 123A and 123B while the current L2 bits of the intersection bit mask are computed and scanned by an fetch unit 132. In an embodiment, the fetch unit 132 includes the registers 123A and 123B for storing the sub-vector bit masks and/or the sub-vector intersection bit mask that are read from the bit mask buffers 122A and 122B. In an embodiment, the bit masks (and optional relevance bit masks) are organized as 32 words of 8 bits in the packed vector memories 110A and 110B. In an embodiment, the bit masks for each sub-vector are organized as 32 words of 8 bits in the bit mask buffers 122.

Each of the scanning units 130 processes L2 bits of the A and B bit masks per processing cycle. L2 should be chosen so that on average the L2 bits produce at least one non-zero bit of the intersection bit mask. For example, as the sparsity of the input vectors increases, L2 should also increase. Each non-zero bit of the intersection bit mask is associated with a non-zero partial product.

After at least one non-zero bit of the intersection bit mask is identified by the fetch unit 132 within the scanning unit 130, the fetch unit 132 then reads the sub-vector buffer 124A and sub-vector buffer 124B to read elements corresponding to a non-zero partial product (according to the sub-vector intersection bit mask) for processing by the multiplier 136. Note that in an embodiment, each buffer 124 is capable of storing an entire 256 element sub-vector.

In an embodiment, the fetch units 132 within the scanning units 130 each examine 8 bits of the 256 bit sub-vector intersection bit mask at a time, where each 8 bits is a word and the total number of words is 32. In an embodiment, each scanning unit 130 computes one partial product per clock cycle, so that up to N partial products are computed in parallel each processing cycle. Because each sub-vector intersection bit mask does not necessarily have the same number of non-zero bits, the scanning units 130 may finish computing partial products at different clock cycles. Furthermore, the scanning units 130 may step through the 32 words at different paces, depending on the number of non-zero bits in each word of the respective sub-vector intersection bit masks. The summing tree 140 may accumulate up to N partial products each cycle, accumulating the output element over multiple processing cycles.

The fetch unit 132 reads the sub-vector bit masks for both A and B sub-vectors from the bit mask buffers 122 by generating memory addresses for the bit mask buffers 122A and 122B. In an embodiment, the fetch unit 132 performs a bitwise AND operation 131 to compute the sub-vector intersection bit mask for the two sub-vectors. The sub-vector intersection bit mask and the vectorA and vectorB bit masks are used by the element fetch unit 132 to compute read addresses for the sub-vector buffers 124 to read the unpacked non-zero elements.

The sub-vector element pairs (one element from each of the sub-vector buffers 124A and 124B) may be provided to a multiplier 136 to compute a partial product. The element fetch unit 132 outputs buffer read addresses (one-hot encoded bit-pointers) for the sub-vector buffers 124 to provide the sub-vector element pair (if any) to the multiplier 136. For any processing cycles where no partial product will be computed, the buffer read addresses computed by the element fetch unit 132 and output to the bit mask buffers 122 and the sub-vector buffers 124 may be gated to avoid toggling signals.

TABLE 3 is example pseudo code for the scanning unit 130 operations after the non-zero elements and bit masks for the A and B sub-vectors are read from the packed vector memory 110A and packed vector memory 110B and stored in the buffers 120A and 120B, respectively. Each L2 bits of the bit masks A_{b} (Abb or vectorA bit mask) and B_{b} (Bbb or vectorB bit mask) are read from the buffers 120A and 120B using the word pointer, p. L2 bits of the sub-vector intersection bit mask Ib are computed by bitwise (intersecting) ANDing of the sub-vector bit masks.

When at least one bit is TRUE in Ib, b is set to the bit position of the first non-zero in Ib and an address is computed to read a non-zero element from the sub-vector buffers 124A and 124B. There is a single address (index) X for both sub-vectors A and B which is a word pointer p concatenated with a bit position b. Note that the bit position b is most efficiently represented in one-hot form and can be used directly to drive a decoder for the sub-vector buffers 124A and 124B (Av and Bv). The one-hot form eliminates the need for a pre-decoder for a portion of the address. The one-hot bit-pointer b is initialized to a value of zero which corresponds to a one in the position off the left (LSB) side of the respective input vector. The nextOne(b,Ib) function called with b=0 returns the first (left-most) one in Ib. The moreOnes(b,Ib) function returns one if there are any ones in Ib to the right of the one in b.

TABLE 3
Example pseudo code for the scanning unit

```
p = 0 ; // word pointer
while(p <= MAX_P) { // for each word
  Abb = Ab[p] ; //read next L2 bits of bit mask
  Bbb = Bb[p] ;
  Ib = Abb & Bbb ; // compute intersection
  if (Ib != 0) { // if intersection not empty
    b = 0 ; // start at LSB
    while(moreOnes(b,Ib)) {
      // for each non-zero of intersection Ib
      b = nextOne(b,Ib) ;
      X = {p,b} ;
      Avv = Av[X] ; // value for A
      Bvv = Bv[X] ; // value for B
      Output Avv * Bvv ;
    }
  }
  p = p + 1 ;
```

The non-zero elements (Avv and Bvv) of the A and B sub-vectors, respectively, are read from the sub-vector buffers 124A and 124B and multiplied by the multiplier 136 to compute a partial product (Output). Additional partial products are computed for each remaining non-zero bit in the intersection bit mask, and the process is repeated for the remaining sub-vectors. Unpacking the non-zero elements as they are written into the buffers 124 by the unpacking units 115 reduces the energy consumed for reading the non-zero elements and simplifies the address calculation for reading from the sub-vector buffers 124, incrementing p every other processing cycle on average depending on the vector density. In an embodiment, the sub-vector buffers 124 store the non-zero vectors in a packed format and the non-zero element positions for computing a non-zero partial product are computed in the same manner as shown in TABLE 1, using the intersection vector instead of the relevance vector.

TABLE 4 illustrates an example computation using the pseudo code shown in TABLE 3. The bit masks for the sub-vectors A and B, Abb and Bbb each include four TRUE bits. However, in this case, the intersection bit mask Ib computed by the bitwise AND operation 131 only includes two TRUE bits. For the first processing cycle a first partial product is computed by the multiplier 136 and for the second processing cycle a second partial product is computed by the multiplier 136.

TABLE 4
Example computation

| | |
|---|---|
| Abb | 01001101 |
| Bbb | 01011010 |
| Ib | 01001000 |

Cycle 0

| | |
|---|---|
| b | 01000000 |

Cycle 1

| | |
|---|---|
| b | 00001000 |

In some cases, Ib may be all zeros, so that no non-zero elements will be read from the sub-vector buffers 124 to compute a partial product. The element fetch unit 132 may “read ahead,” reading the next word of the bit masks and computing the next sub-vector intersection bit mask while one or more partial products are computed for the current sub-vector intersection bit mask. For example, if the vectors A and B are both 50% dense and the density is uncorrelated, then on average the intersection bit masks will be 25% dense (25% TRUE bits). With L2=8 bits, there will be two TRUE bits on average in each sub-vector intersection bit mask and zero TRUE bits will occur about 10% of the time. When zero TRUE bits occur, a processing cycle for computing a partial product is wasted. A larger value of L2 can be used to reduce the probability of idle processing cycles.

The incidence of wasted processing cycles can be greatly reduced by reading ahead when there is more than one TRUE bit in the current sub-vector intersection bit mask. When the sub-vector bit masks A_{b} and B_{b} are stored in a register by the scanning unit 130, then on the next processing cycle the sub-vector bit masks in location p+1 can be read and the next sub-vector bit masks can be checked for zero. If there is a second TRUE bit in the current sub-vector intersection bit mask, the sub-vector bit masks in location p+2 can be read. When reading ahead, only an intersection bit mask of all zeros in the initial word or W consecutive intersection bit masks of all zeros following an intersection bit mask with W non-zero bits will cause a lost processing cycle. TABLE 5 illustrates the read ahead operation to avoid lost processing cycles.

TABLE 5
Read ahead example
Cycle 0

| | |
|---|---|
| p | 0 |
| Abb | 01001101 |
| Bbb | 01011010 |
| Ib | 01001000 |
| p1 | 0 |
| Ib1 | 01001000 |
| b | 01000000 |

Cycle 1

| | |
|---|---|
| p | 1 |
| Abb | 00100010 |
| Bbb | 01000100 |
| Ib | 00000000 |
| p1 | 0 |
| Ib1 | 01001000 |
| b | 00001000 |

Cycle 2

| | |
|---|---|
| p | 2 |
| Abb | 11001100 |
| Bbb | 01101100 |
| Ib | 01001100 |
| p1 | 2 |
| Ib1 | 01001100 |
| B | 01000000 |

In this example the first word of the sub-vector intersection bit mask Ib has two non-zeros. The sub-vector intersection bit mask and word pointer p are latched or registered as Ib1 and p1. The first non-zero elements for the sub-vectors A and B (p1=0 b=01000000) are read from the buffers 120 on a first processing cycle 0. On a second processing cycle 1, while the second non-zeros of the first sub-vectors A and B are processed (p1=0, b=00001000), the second p=1, sub-vector bit masks are read from the buffers 120 and the second sub-vector intersection bit mask has zero non-zeros. On the third processing cycle 2, the third sub-vector bit masks are read and the third sub-vector intersection bit mask is computed (p=2 Ib=01001100). The all zero second sub-vector intersection bit mask at p=1 is covered by the second non-zero in the first sub-vector intersection bit mask of p=0 so there is no idle cycle when a partial product is not computed.

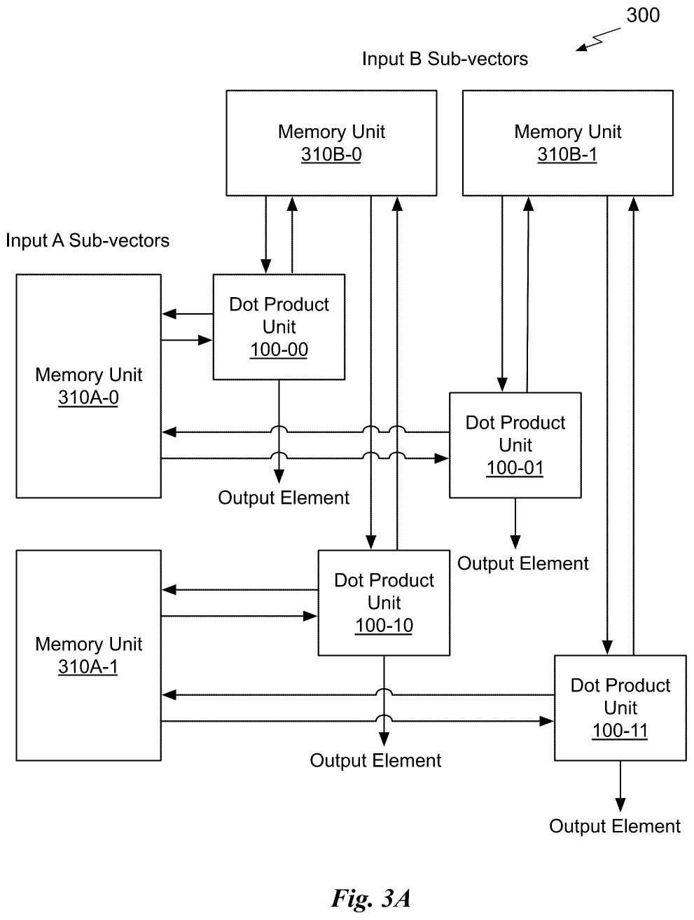

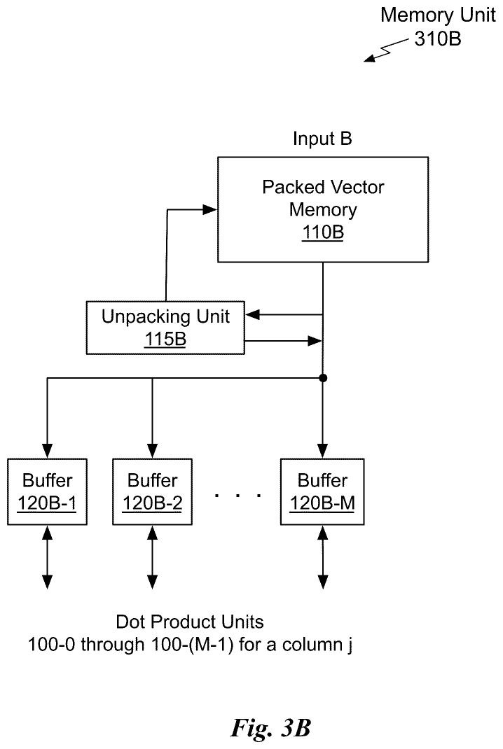

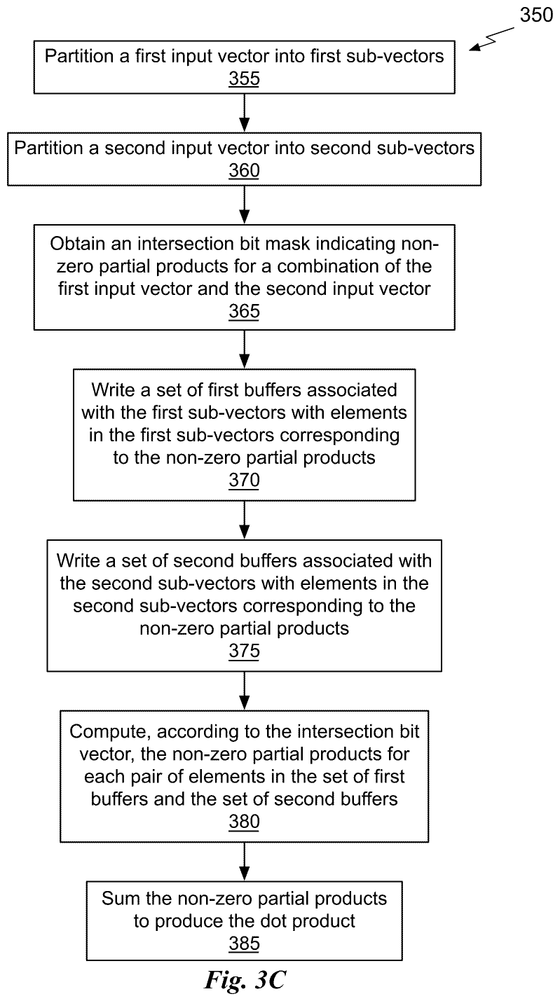

FIG. 3A illustrates a block diagram of a matrix multiply unit 300, in accordance with an embodiment. The dot product units 100 may be used to construct an M×M matrix multiply unit, such as a 2×2 matrix multiply unit 300 shown in FIG. 3A. In an embodiment, the inputs A and B are P×Q and Q×R input matrices respectively and a matrix multiply unit computes L×M submatrices of the output matrix simultaneously, such as a 2×2 submatrix, as shown in FIG. 3A. In other embodiments, greater parallelism is achieved by increasing the number of dot product units 100. In an embodiment, the input matrices are at least N×L1 in each dimension, typically 4,096 elements.

Memory units 310A each comprise a packed vector memory 110A, an unpacking unit 115A, and buffers 120A for storing a row (i) of the A matrix. Memory units 310B each comprise a packed vector memory 110B, an unpacking unit 115B, and buffers 120B for storing a column (j) of the B matrix (see FIG. 3B). Each dot product unit 100-ij computes one element i,j in the output product matrix and includes N scanning units 130 as shown in FIG. 2A. Each of the buffers 120A-i and 120B-j includes bit mask (A_{bi} and B_{bj}) and element (Aᵥᵢ and Bᵥⱼ) components. Each of these components in turn is subdivided into N sub-vectors. Note that the buffers 120A within the memory unit 310A-0 are shared by the dot product units 100-00 and 100-01. Sharing the buffers 120A within each memory unit 310A-i by each dot product unit 100 in the same row enables reuse of the bit masks and non-zero values stored in the buffers 120A for multiple columns of B. Similarly, sharing the buffers 120B within each memory unit 310B-j by each dot product unit 100 in the same column enables reuse of the bit masks and non-zero values stored in the buffers 120B for multiple rows of A.

An example data flow for multiplying matrices of size K×K where K>M is to load the first M rows of A and then load M columns of B in sequence until all K columns of B are processed. Such a data flow re-uses the A matrix elements and bit masks stored in the buffers 120A. Loading non-zero B values into the buffers 120B may be avoided when no corresponding non-zero elements of A are present in the M rows of A. The A bit masks for the M rows of A may be bitwise ORed by the unpacking units 115 to compute a composite (relevance) bit mask that disables fetching and unpacking of any corresponding non-zero elements of B from the packed vector memory 110B. The OR-ing of the A_{b} bit masks may be most easily accomplished while loading the rows of A into the packed vector memory 110A and the composite bit mask can be stored in an additional bit vector buffer AO_{b}.

In an embodiment, each buffer 120Ai or 120Bj is M-ported to provide simultaneous access by M dot-product units 100. In an embodiment, the buffers 120 are doubled buffers so the next column of B is loaded into the buffers 120B by the unpacking unit 115B while the current column of B is used by the scanning units 130 for generating partial products. While partial products are computed for the last column of B, the next row of A can be loaded into the buffers 120A by the unpacking unit 115A. Each scanning unit 130-k within a dot-product unit 100-ij generates pointer pᵢⱼₖ for each sub-vector k to fetch the A bit mask (A_{bb}) and the B bit mask (B_{bb}) from the buffer 120A-ik and the buffer 120B-jk, respectively. Then, after computing Xᵢⱼₖ and p1ᵢⱼₖ, the scanning unit 130-k uses the pointer to fetch Aᵥᵥ and Bᵥᵥ from the buffer 120A-ik and the buffer 120B-jk, respectively. The scanning unit 130-k performs the multiplication and feeds the output into the summing tree 140 for element i,j in the output product matrix. There are N*M² scanning units 130 computing pointers each processing cycle.

FIG. 3B illustrates a block diagram of a memory unit 310, in accordance with an embodiment. As shown, the memory unit 310B comprises a packed vector memory 110B, an unpacking unit 115B, and N buffers 120B for storing a column (j) of the B matrix.

FIG. 3C illustrates a flowchart of a method 350 performing an operation using sparse input vectors suitable for use in implementing some embodiments of the present disclosure. Each block of method 350, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 350 is described, by way of example, with respect to the dot product unit 100 of FIG. 1A and the matrix multiply unit 300 of FIG. 3A. However, this method may additionally or alternatively be executed by any one system, or any combination of systems, including, but not limited to, those described herein. Furthermore, persons of ordinary skill in the art will understand that any system that performs method 350 is within the scope and spirit of embodiments of the present disclosure.

At step 355, a first input vector is partitioned into first sub-vectors. At step 360, a second input vector is partitioned into second sub-vectors. In an embodiment, the operation is a matrix multiply, the first input vector is a row of a first matrix, and the second input vector comprises a column of a second matrix. At step 365, an intersection bit mask indicating non-zero partial products for a combination of the first input vector and the second input vector is obtained. In an embodiment, the intersection bit mask is computed by performing a bitwise AND operation on a first bit mask indicating non-zero elements of the first input vector and a second bit mask indicating non-zero elements of the second input vector.

At step 370, a set of first buffers associated with the first sub-vectors is written with first elements in the first sub-vectors corresponding to the non-zero partial products. In an embodiment, the first input vector is partitioned into N first sub-vectors and N multipliers each compute one of the non-zero partial products in the corresponding first sub-vector each processing cycle. In an embodiment, the second input vector is also partitioned into N first sub-vectors. In an embodiment, elements in the first sub-vectors corresponding to zero partial products according to the intersection bit mask are not written to the set of first buffers. In an embodiment, a one-hot pointer derived from the intersection bit mask is used to determine locations of the first elements in the first buffers. In an embodiment, writing the set of first buffers comprises reading the first elements from a memory that stores the first elements in a packed format and unpacking the first elements when writing the set of first buffers.

At 375, a set of second buffers associated with the second sub-vectors is written with second elements in the second sub-vectors corresponding to the non-zero partial products. In an embodiment, the one-hot pointer derived from the intersection bit mask is used to determine locations of the second elements in the second buffers. In an embodiment, writing the set of second buffers comprises reading the second elements from a second memory that stores the second elements in a packed format and unpacking the second elements when writing the set of second buffers.

At step 380, the non-zero partial products for each pair of elements including one of the first elements and one of the second elements are computed, according to the intersection bit vector. In an embodiment, the intersection bit mask corresponds to a first sub-vector of the first input vector and the second input vector and further comprising reading a portion of the first bit mask and the second bit mask corresponding to a second sub-vector of the first input vector and the second input vector during the computing.

At step 385, the non-zero partial products are summed to produce a dot product of the first input vector and the second input vector. In an embodiment, the first matrix and the second matrix each include at least two rows and at least two columns that are simultaneously processed to produce the non-zero partial products. When the operation is a matrix multiply between a first and second matrix, in an embodiment, a relevance bit mask is computed for each row of the second matrix by: performing a bitwise OR operation on a first bit mask indicating non-zero elements of a first column of the first matrix and a second bit mask indicating non-zero elements of each additional column of the first matrix to compute a column bit mask; and performing a bitwise AND operation on a second bit mask indicating non-zero elements of the row of the second matrix and the column bit mask to compute the relevance bit mask. In an embodiment, the relevance bit mask is used to: identify the first elements that are read from a memory that stores the first elements in a packed format and write the first elements to the set of first buffers. The unpacker 115 uses the relevance bit mask to load the buffer 120A with the non-zero elements for a row of input A to multiply by the non-zero elements for multiple columns of input B.

In an embodiment, when the operation is a matrix multiply, at least one additional row of the first matrix is partitioned into first additional sub-vectors and the steps of obtaining, writing the set of first buffers, computing, and summing are performed in parallel for the row of the first matrix and the at least one additional column of the second matrix. In an embodiment, when the operation is a matrix multiply, at least one additional column of the second matrix is partitioned into first additional sub-vectors and the steps of obtaining, writing the set of second buffers, computing, and summing are performed in parallel for the at least one additional column of the second matrix and the row of the first matrix.

In an embodiment, at least one of the steps 370, 375, 380, and 385 is performed on a server or in a data center to generate data, and the data are streamed to a user device. In an embodiment, at least one of the steps 370, 375, 380, and 385 is performed within a cloud computing environment. In an embodiment, at least one of the steps 370, 375, 380, and 385 is performed for training, testing, or certifying a neural network employed in a machine, robot, or autonomous vehicle. In an embodiment, at least one of the steps 370, 375, 380, and 385 is performed on a virtual machine comprising a portion of a graphics processing unit.

A sparse dot product and/or matrix multiply is computed by subdividing each vector into sub-vectors and simultaneously performing operations on the sub-vectors to generate output matrix elements. In an embodiment, a bit mask is computed that includes one bit for each element of an input matrix, each bit indicating whether the element is non-zero or zero. The bit mask can then be used to determine the location of each non-zero element in the packed storage. Rather than reading all of the elements, only the non-zero elements that will be multiplied by a non-zero element from the other input vector are read and multiplied to reduce bandwidth and power consumption. Any multiplication by a zero element from either input vector or matrix is unnecessary.

In an embodiment, the element values are stored in a packed format, where all of the non-zero values are packed together and the remaining storage for the matrix contains zeros (or any other values). The non-zero elements may be unpacked as they are stored to local buffers to reduce bandwidth and power consumption. The read address computation to read from the local buffers is an efficient combinatorial computation. Further efficiency may be achieved by reading bit masks for the next sub-vector while the current sub-vector is processed to minimize lost processing cycles.

### Parallel Processing Architecture

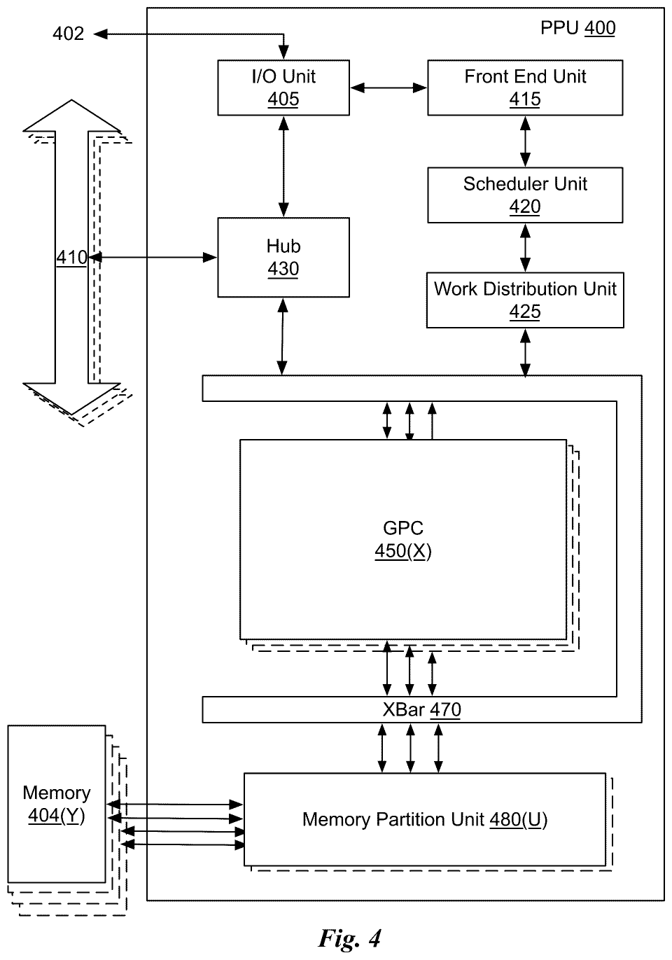

FIG. 4 illustrates a parallel processing unit (PPU) 400, in accordance with an embodiment. The PPU 400 may be used to implement the dot product unit 100 of FIG. 1A and/or the matrix multiply unit 300 of FIG. 3A. The PPU 400 may be used to implement one or more of the packed vector memories 110, buffers 120, scanning units 130, and summing tree 140. In an embodiment, a processor such as the PPU 400 may be configured to implement a neural network model. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the PPU 400 is a multi-threaded processor that is implemented on one or more integrated circuit devices. The PPU 400 is a latency hiding architecture designed to process many threads in parallel. A thread (e.g., a thread of execution) is an instantiation of a set of instructions configured to be executed by the PPU 400. In an embodiment, the PPU 400 is a graphics processing unit (GPU) configured to implement a graphics rendering pipeline for processing three-dimensional (3D) graphics data in order to generate two-dimensional (2D) image data for display on a display device. In other embodiments, the PPU 400 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 400 may be configured to accelerate thousands of High Performance Computing (HPC), data center, cloud computing, and machine learning applications. The PPU 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 4, the PPU 400 includes an Input/Output (I/O) unit 405, a front end unit 415, a scheduler unit 420, a work distribution unit 425, a hub 430, a crossbar (Xbar) 470, one or more general processing clusters (GPCs) 450, and one or more memory partition units 480. The PPU 400 may be connected to a host processor or other PPUs 400 via one or more high-speed NVLink 410 interconnect. The PPU 400 may be connected to a host processor or other peripheral devices via an interconnect 402. The PPU 400 may also be connected to a local memory 404 comprising a number of memory devices. In an embodiment, the local memory may comprise a number of dynamic random access memory (DRAM) devices. The DRAM devices may be configured as a high-bandwidth memory (HBM) subsystem, with multiple DRAM dies stacked within each device.

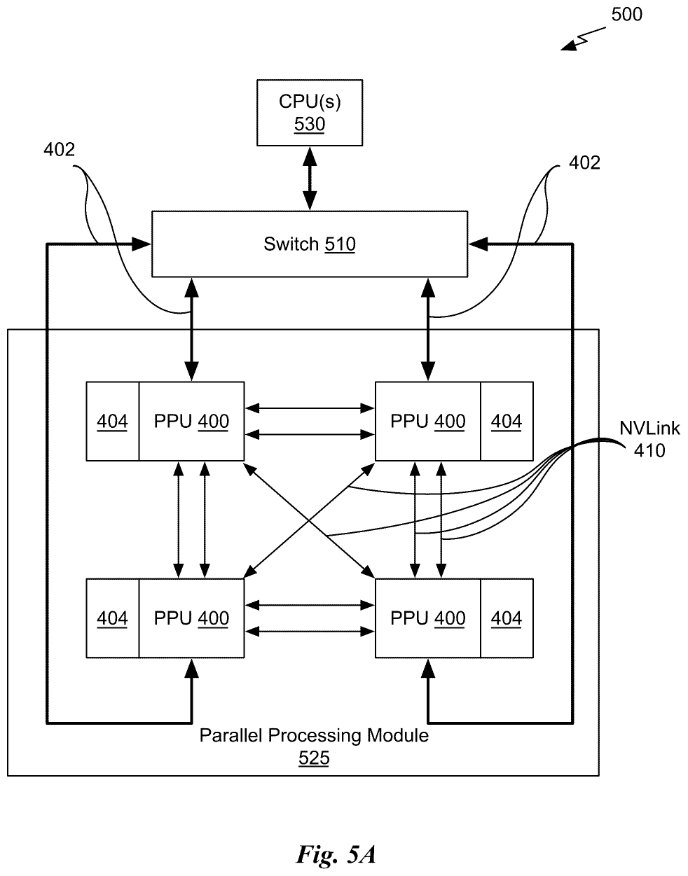

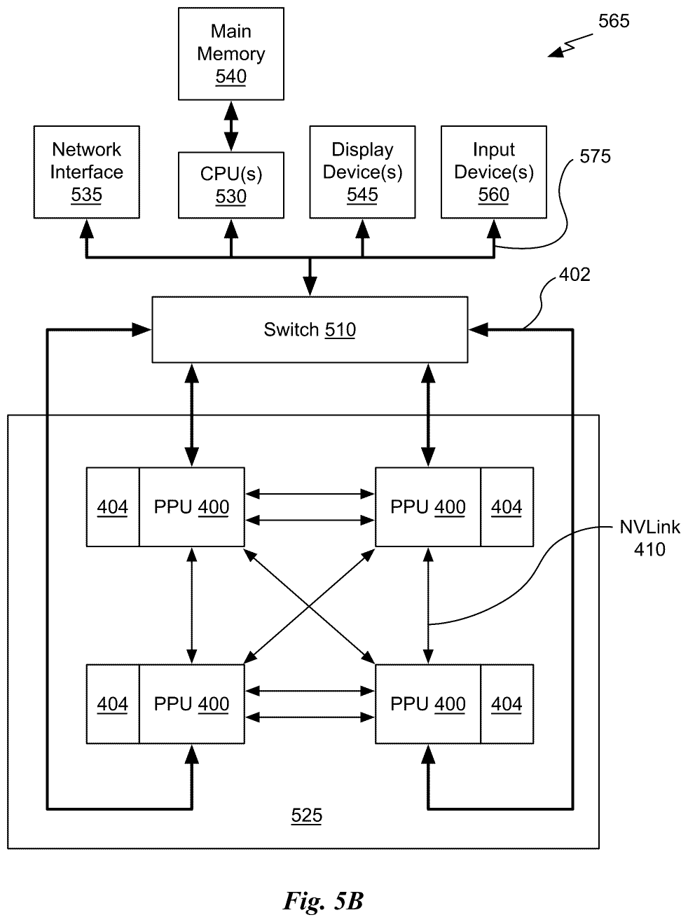

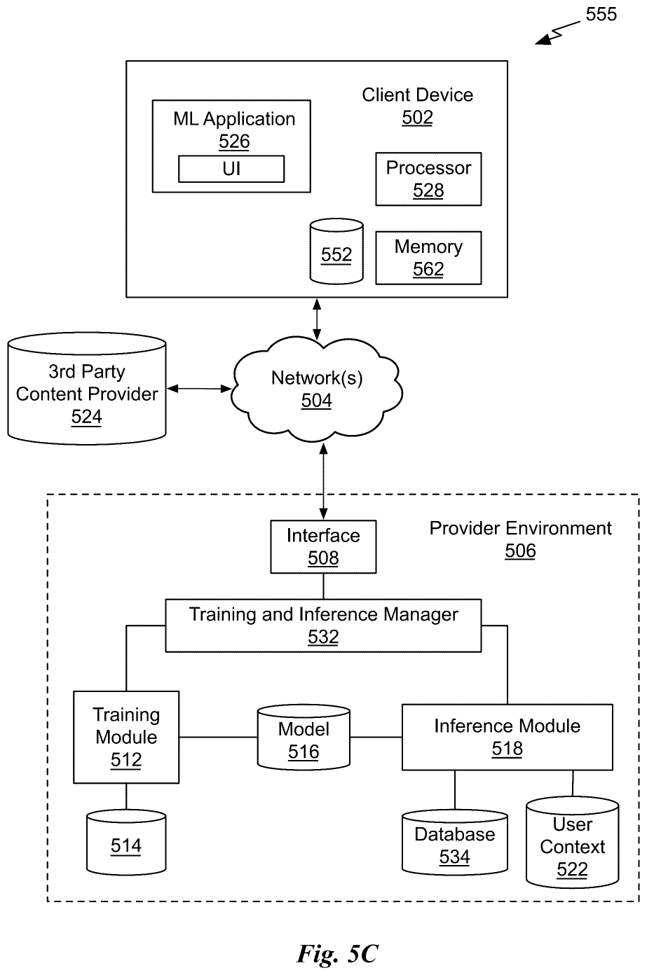

The NVLink 410 interconnect enables systems to scale and include one or more PPUs 400 combined with one or more CPUs, supports cache coherence between the PPUs 400 and CPUs, and CPU mastering. Data and/or commands may be transmitted by the NVLink 410 through the hub 430 to/from other units of the PPU 400 such as one or more copy engines, a video encoder, a video decoder, a power management unit, etc. (not explicitly shown). The NVLink 410 is described in more detail in conjunction with FIG. 5B.

The I/O unit 405 is configured to transmit and receive communications (e.g., commands, data, etc.) from a host processor (not shown) over the interconnect 402. The I/O unit 405 may communicate with the host processor directly via the interconnect 402 or through one or more intermediate devices such as a memory bridge. In an embodiment, the I/O unit 405 may communicate with one or more other processors, such as one or more the PPUs 400 via the interconnect 402. In an embodiment, the I/O unit 405 implements a Peripheral Component Interconnect Express (PCIe) interface for communications over a PCIe bus and the interconnect 402 is a PCIe bus. In alternative embodiments, the I/O unit 405 may implement other types of well-known interfaces for communicating with external devices.

The I/O unit 405 decodes packets received via the interconnect 402. In an embodiment, the packets represent commands configured to cause the PPU 400 to perform various operations. The I/O unit 405 transmits the decoded commands to various other units of the PPU 400 as the commands may specify. For example, some commands may be transmitted to the front end unit 415. Other commands may be transmitted to the hub 430 or other units of the PPU 400 such as one or more copy engines, a video encoder, a video decoder, a power management unit, etc. (not explicitly shown). In other words, the I/O unit 405 is configured to route communications between and among the various logical units of the PPU 400.

In an embodiment, a program executed by the host processor encodes a command stream in a buffer that provides workloads to the PPU 400 for processing. A workload may comprise several instructions and data to be processed by those instructions. The buffer is a region in a memory that is accessible (e.g., read/write) by both the host processor and the PPU 400. For example, the I/O unit 405 may be configured to access the buffer in a system memory connected to the interconnect 402 via memory requests transmitted over the interconnect 402. In an embodiment, the host processor writes the command stream to the buffer and then transmits a pointer to the start of the command stream to the PPU 400. The front end unit 415 receives pointers to one or more command streams. The front end unit 415 manages the one or more streams, reading commands from the streams and forwarding commands to the various units of the PPU 400.

The front end unit 415 is coupled to a scheduler unit 420 that configures the various GPCs 450 to process tasks defined by the one or more streams. The scheduler unit 420 is configured to track state information related to the various tasks managed by the scheduler unit 420. The state may indicate which GPC 450 a task is assigned to, whether the task is active or inactive, a priority level associated with the task, and so forth. The scheduler unit 420 manages the execution of a plurality of tasks on the one or more GPCs 450.

The scheduler unit 420 is coupled to a work distribution unit 425 that is configured to dispatch tasks for execution on the GPCs 450. The work distribution unit 425 may track a number of scheduled tasks received from the scheduler unit 420. In an embodiment, the work distribution unit 425 manages a pending task pool and an active task pool for each of the GPCs 450. As a GPC 450 finishes the execution of a task, that task is evicted from the active task pool for the GPC 450 and one of the other tasks from the pending task pool is selected and scheduled for execution on the GPC 450. If an active task has been idle on the GPC 450, such as while waiting for a data dependency to be resolved, then the active task may be evicted from the GPC 450 and returned to the pending task pool while another task in the pending task pool is selected and scheduled for execution on the GPC 450.

In an embodiment, a host processor executes a driver kernel that implements an application programming interface (API) that enables one or more applications executing on the host processor to schedule operations for execution on the PPU 400. In an embodiment, multiple compute applications are simultaneously executed by the PPU 400 and the PPU 400 provides isolation, quality of service (QOS), and independent address spaces for the multiple compute applications. An application may generate instructions (e.g., API calls) that cause the driver kernel to generate one or more tasks for execution by the PPU 400. The driver kernel outputs tasks to one or more streams being processed by the PPU 400. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. The tasks may be allocated to one or more processing units within a GPC 450 and instructions are scheduled for execution by at least one warp.

The work distribution unit 425 communicates with the one or more GPCs 450 via XBar 470. The XBar 470 is an interconnect network that couples many of the units of the PPU 400 to other units of the PPU 400. For example, the XBar 470 may be configured to couple the work distribution unit 425 to a particular GPC 450. Although not shown explicitly, one or more other units of the PPU 400 may also be connected to the XBar 470 via the hub 430.

The tasks are managed by the scheduler unit 420 and dispatched to a GPC 450 by the work distribution unit 425. The GPC 450 is configured to process the task and generate results. The results may be consumed by other tasks within the GPC 450, routed to a different GPC 450 via the XBar 470, or stored in the memory 404. The results can be written to the memory 404 via the memory partition units 480, which implement a memory interface for reading and writing data to/from the memory 404. The results can be transmitted to another PPU 400 or CPU via the NVLink 410. In an embodiment, the PPU 400 includes a number U of memory partition units 480 that is equal to the number of separate and distinct memory devices of the memory 404 coupled to the PPU 400. Each GPC 450 may include a memory management unit to provide translation of virtual addresses into physical addresses, memory protection, and arbitration of memory requests. In an embodiment, the memory management unit provides one or more translation lookaside buffers (TLBs) for performing translation of virtual addresses into physical addresses in the memory 404.

In an embodiment, the memory partition unit 480 includes a Raster Operations (ROP) unit, a level two (L2) cache, and a memory interface that is coupled to the memory 404. The memory interface may implement 32, 64, 128, 1024-bit data buses, or the like, for high-speed data transfer. The PPU 400 may be connected to up to Y memory devices, such as high bandwidth memory stacks or graphics double-data-rate, version 5, synchronous dynamic random access memory, or other types of persistent storage. In an embodiment, the memory interface implements an HBM2 memory interface and Y equals half U. In an embodiment, the HBM2 memory stacks are located on the same physical package as the PPU 400, providing substantial power and area savings compared with conventional GDDR5 SDRAM systems. In an embodiment, each HBM2 stack includes four memory dies and Y equals 4, with each HBM2 stack including two 128-bit channels per die for a total of 8 channels and a data bus width of 1024 bits.

In an embodiment, the memory 404 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 400 process very large datasets and/or run applications for extended periods.

In an embodiment, the PPU 400 implements a multi-level memory hierarchy. In an embodiment, the memory partition unit 480 supports a unified memory to provide a single unified virtual address space for CPU and PPU 400 memory, enabling data sharing between virtual memory systems. In an embodiment the frequency of accesses by a PPU 400 to memory located on other processors is traced to ensure that memory pages are moved to the physical memory of the PPU 400 that is accessing the pages more frequently. In an embodiment, the NVLink 410 supports address translation services allowing the PPU 400 to directly access a CPU's page tables and providing full access to CPU memory by the PPU 400.

In an embodiment, copy engines transfer data between multiple PPUs 400 or between PPUs 400 and CPUs. The copy engines can generate page faults for addresses that are not mapped into the page tables. The memory partition unit 480 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 404 or other system memory may be fetched by the memory partition unit 480 and stored in an L2 cache, which is located on-chip and is shared between the various GPCs 450. As shown, each memory partition unit 480 includes a portion of the L2 cache associated with a corresponding memory 404. Lower level caches may then be implemented in various units within the GPCs 450. For example, each of the processing units within a GPC 450 may implement a level one (L1) cache. The L1 cache is private memory that is dedicated to a particular processing unit. The L2 cache is coupled to the memory interface 470 and the XBar 470 and data from the L2 cache may be fetched and stored in each of the L1 caches for processing.

In an embodiment, the processing units within each GPC 450 implement a SIMD (Single-Instruction, Multiple-Data) architecture where each thread in a group of threads (e.g., a warp) is configured to process a different set of data based on the same set of instructions. All threads in the group of threads execute the same instructions. In another embodiment, the processing unit implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

Each processing unit includes a large number (e.g., 128, etc.) of distinct processing cores (e.g., functional units) that may be fully-pipelined, single-precision, double-precision, and/or mixed precision and include a floating point arithmetic logic unit and an integer arithmetic logic unit. In an embodiment, the floating point arithmetic logic units implement the IEEE 754-2008 standard for floating point arithmetic. In an embodiment, the cores include 64 single-precision (32-bit) floating point cores, 64 integer cores, 32 double-precision (64-bit) floating point cores, and 8 tensor cores.

Tensor cores configured to perform matrix operations. In particular, the tensor cores are configured to perform deep learning matrix arithmetic, such as GEMM (matrix-matrix multiplication) for convolution operations during neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B may be integer, fixed-point, or floating point matrices, while the accumulation matrices C and D may be integer, fixed-point, or floating point matrices of equal or higher bitwidths. In an embodiment, tensor cores operate on one, four, or eight bit integer input data with 32-bit integer accumulation. The 8-bit integer matrix multiply requires 1024 operations and results in a full precision product that is then accumulated using 32-bit integer addition with the other intermediate products for a 8×8×16 matrix multiply. In an embodiment, tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each processing unit may also comprise M special function units (SFUs) that perform special functions (e.g., attribute evaluation, reciprocal square root, and the like). In an embodiment, the SFUs may include a tree traversal unit configured to traverse a hierarchical tree data structure. In an embodiment, the SFUs may include texture unit configured to perform texture map filtering operations. In an embodiment, the texture units are configured to load texture maps (e.g., a 2D array of texels) from the memory 404 and sample the texture maps to produce sampled texture values for use in shader programs executed by the processing unit. In an embodiment, the texture maps are stored in shared memory that may comprise or include an L1 cache. The texture units implement texture operations such as filtering operations using mip-maps (e.g., texture maps of varying levels of detail). In an embodiment, each processing unit includes two texture units.

Each processing unit also comprises N load store units (LSUs) that implement load and store operations between the shared memory and the register file. Each processing unit includes an interconnect network that connects each of the cores to the register file and the LSU to the register file, shared memory. In an embodiment, the interconnect network is a crossbar that can be configured to connect any of the cores to any of the registers in the register file and connect the LSUs to the register file and memory locations in shared memory.

The shared memory is an array of on-chip memory that allows for data storage and communication between the processing units and between threads within a processing unit. In an embodiment, the shared memory comprises 128 KB of storage capacity and is in the path from each of the processing units to the memory partition unit 480. The shared memory can be used to cache reads and writes. One or more of the shared memory, L1 cache, L2 cache, and memory 404 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory enables the shared memory to function as a high-throughput conduit for streaming data while simultaneously providing high-bandwidth and low-latency access to frequently reused data.

When configured for general purpose parallel computation, a simpler configuration can be used compared with graphics processing. Specifically, fixed function graphics processing units, are bypassed, creating a much simpler programming model. In the general purpose parallel computation configuration, the work distribution unit 425 assigns and distributes blocks of threads directly to the processing units within the GPCs 450. Threads execute the same program, using a unique thread ID in the calculation to ensure each thread generates unique results, using the processing unit(s) to execute the program and perform calculations, shared memory to communicate between threads, and the LSU to read and write global memory through the shared memory and the memory partition unit 480. When configured for general purpose parallel computation, the processing units can also write commands that the scheduler unit 420 can use to launch new work on the processing units.

The PPUs 400 may each include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The PPU 400 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 400 is embodied on a single semiconductor substrate. In another embodiment, the PPU 400 is included in a system-on-a-chip (SoC) along with one or more other devices such as additional PPUs 400, the memory 404, a reduced instruction set computer (RISC) CPU, a memory management unit (MMU), a digital-to-analog converter (DAC), and the like.

In an embodiment, the PPU 400 may be included on a graphics card that includes one or more memory devices. The graphics card may be configured to interface with a PCIe slot on a motherboard of a desktop computer. In yet another embodiment, the PPU 400 may be an integrated graphics processing unit (iGPU) or parallel processor included in the chipset of the motherboard. In yet another embodiment, the PPU 400 may be realized in reconfigurable hardware. In yet another embodiment, parts of the PPU 400 may be realized in reconfigurable hardware.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 5A is a conceptual diagram of a processing system 500 implemented using the PPU 400 of FIG. 4, in accordance with an embodiment. The exemplary system 500 may be configured to implement the method 350 shown in FIG. 3C. The processing system 500 includes a CPU 530, switch 510, and multiple PPUs 400, and respective memories 404.

The NVLink 410 provides high-speed communication links between each of the PPUs 400. Although a particular number of NVLink 410 and interconnect 402 connections are illustrated in FIG. 5B, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 5A, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 5A, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

FIG. 5B illustrates an exemplary system 565 in which the various architecture and/or functionality of the various previous embodiments may be implemented. The exemplary system 565 may be configured to implement the method 350 shown in FIG. 3C.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5B are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5B.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 5A and/or exemplary system 565 of FIG. 5B—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 5A and/or exemplary system 565 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In an embodiment, the set of training data may be used in a generative adversarial training configuration to train a generator neural network.

In at least one embodiment, training data can include images of at least one human subject, avatar, or character for which a neural network is to be trained. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

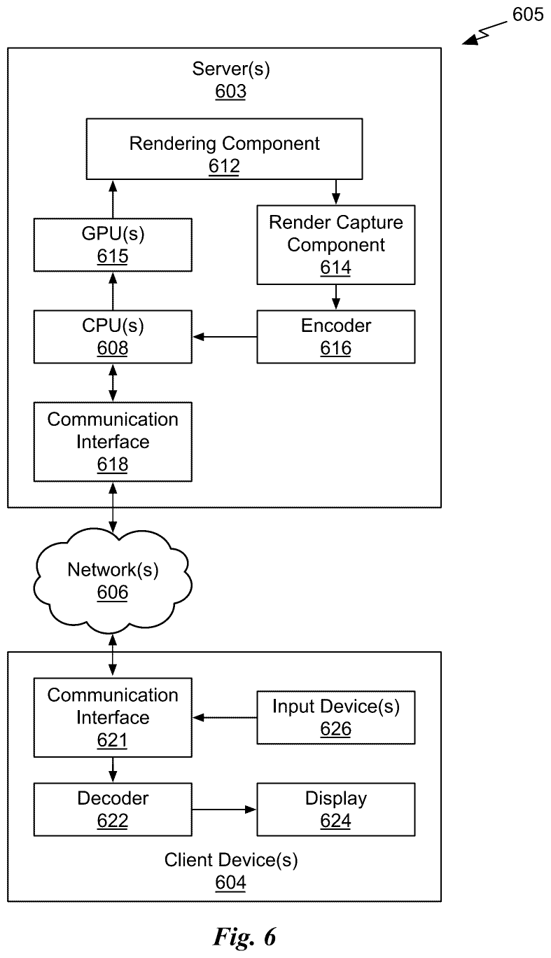

FIG. 6 is an example system diagram for a streaming system 605, in accordance with some embodiments of the present disclosure. FIG. 6 includes server(s) 603 (which may include similar components, features, and/or functionality to the example processing system 500 of FIG. 5A and/or exemplary system 565 of FIG. 5B), client device(s) 604 (which may include similar components, features, and/or functionality to the example processing system 500 of FIG. 5A and/or exemplary system 565 of FIG. 5B), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A method for performing an operation using sparse input vectors, comprising:
partitioning a first input vector into first sub-vectors;
partitioning a second input vector into second sub-vectors;
obtaining an intersection bit mask indicating non-zero partial products for a combination of the first input vector and the second input vector;
writing a set of first buffers associated with the first sub-vectors with first elements in the first sub-vectors corresponding to the non-zero partial products;
writing a set of second buffers associated with the second sub-vectors with second elements in the second sub-vectors corresponding to the non-zero partial products;
computing, according to the intersection bit mask, the non-zero partial products for each pair of elements including one of the first elements and one of the second elements; and
summing the non-zero partial products to produce a dot product of the first input vector and the second input vector.

2. The method of claim 1, wherein the first input vector is partitioned into N first sub-vectors and N multipliers each compute one of the non-zero partial products in the corresponding first sub-vector each processing cycle.

3. The method of claim 1, wherein elements in the first sub-vectors corresponding to zero partial products according to the intersection bit mask are not written to the set of first buffers.

4. The method of claim 1, wherein the intersection bit mask is computed by performing a bitwise AND operation on a first bit mask indicating non-zero elements of the first input vector and a second bit mask indicating non-zero elements of the second input vector.

5. The method of claim 1, wherein the intersection bit mask corresponds to a first sub-vector of the first input vector and the second input vector and further comprising reading a portion of the first bit mask and the second bit mask corresponding to a second sub-vector of the first input vector and the second input vector during the computing.

6. The method of claim 1, wherein a one-hot pointer derived from the intersection bit mask is used to determine locations of the first elements in the first buffers.

7. The method of claim 6, wherein writing the set of first buffers comprises reading the first elements from a memory that stores the first elements in a packed format and unpacking the first elements when writing the set of first buffers.

8. The method of claim 1, wherein the operation is a matrix multiply, the first input vector is a row of a first matrix, and the second input vector comprises a column of a second matrix.

9. The method of claim 8, wherein the first matrix and the second matrix each include at least two rows and at least two columns that are simultaneously processed to produce the non-zero partial products.

10. The method of claim 9, further comprising computing a relevance bit mask for each row of the second matrix by:
performing a bitwise OR operation on a first bit mask indicating non-zero elements of a first column of the first matrix and a second bit mask indicating non-zero elements of each additional column of the first matrix to compute a column bit mask; and
performing a bitwise AND operation on a second bit mask indicating non-zero elements of the row of the second matrix and the column bit mask to compute the relevance bit mask.

11. The method of claim 10, wherein the relevance bit mask is used to:
identify the first elements that are read from a memory that stores the first elements in a packed format; and
write the first elements to the set of first buffers.

12. The method of claim 8, wherein at least one additional row of the first matrix is partitioned into first additional sub-vectors and the steps of obtaining, writing the set of first buffers, computing, and summing are performed in parallel for the at least one additional row of the first matrix and the column of the second matrix.

13. The method of claim 8, wherein at least one additional column of the second matrix is partitioned into first additional sub-vectors and the steps of obtaining, writing the set of second buffers, computing, and summing are performed in parallel for the at least one additional column of the second matrix and the row of the first matrix.

14. The method of claim 1, wherein at least one of the steps of writing the set of first buffers, writing the set of second buffers, computing, or summing is performed on a server or in a data center to generate data, and the data are streamed to a user device.

15. The method of claim 1, wherein at least one of the steps of writing the set of first buffers, writing the set of second buffers, computing, or summing is performed within a cloud computing environment.

16. The method of claim 1, wherein at least one of the steps of writing the set of first buffers, writing the set of second buffers, computing, or summing is performed for training, testing, or certifying a neural network employed in a machine, robot, or autonomous vehicle.

17. The method of claim 1, wherein at least one of the steps of writing the set of first buffers, writing the set of second buffers, computing, or summing is performed on a virtual machine comprising a portion of a graphics processing unit.

18. A system, comprising:
a memory that stores a first input vector and a second input vector; and
a processor that is connected to the memory, wherein the processor performs an operation using sparse input vectors by:
partitioning the first input vector into first sub-vectors;
partitioning the second input vector into second sub-vectors;
obtaining a intersection bit mask indicating non-zero partial products for a combination of the first input vector and the second input vector;
writing a set of first buffers associated with the first sub-vectors with first elements in the first sub-vectors corresponding to the non-zero partial products;
writing a set of second buffers associated with the second sub-vectors with second elements in the second sub-vectors corresponding to the non-zero partial products;
computing, according to the intersection bit mask, the non-zero partial products for each pair of elements including one of the first elements and one of the second elements; and
summing the non-zero partial products to produce a dot product of the first input vector and the second input vector.

19. The system of claim 18, wherein the first input vector is partitioned into N first sub-vectors and N multipliers each compute one of the non-zero partial products in the corresponding first sub-vector each processing cycle.

20. The system of claim 18, wherein the intersection bit mask is computed by performing a bitwise AND operation on a first bit mask indicating non-zero elements of the first input vector and a second bit mask indicating non-zero elements of the second input vector.

21. The system of claim 18, wherein a one-hot pointer derived from the intersection bit mask is used to determine locations of the first elements in the first buffers.

22. The system of claim 21, wherein writing the set of first buffers comprises reading the first elements from a memory that stores the first elements in a packed format and unpacking the first elements when writing the set of first buffers.

23. The system of claim 18, wherein the operation is a matrix multiply, the first input vector is a row of a first matrix, and the second input vector comprises a column of a second matrix.
